(19) United States
(12) Patent Application Publication
(10) Pub. No.: US 2025/0132624 A1
(43) Pub. Date: Apr. 24, 2025

(54) AXIAL FLUX ELECTRICAL MACHINE WITH CIRCUMFERENTIALLY INCLINED STATOR WINDING SPOKES

(71) Applicant: LITENS AUTOMOTIVE PARTNERSHIP, Woodbridge (CA)

(72) Inventors: Matthew VIOLA, Woodbridge (CA); Geoffrey William RYELAND, North York (CA)

(21) Appl. No.: 18/924,621

(22) Filed: Oct. 23, 2024

Related U.S. Application Data
(60) Provisional application No. 63/592,389, filed on Oct. 23, 2023.

(51) Int. Cl. H02K 3/28; H02K 1/14

(52) U.S. Cl. CPC H02K 3/28; H02K 1/14; H02K 2203/03; H02K 2211/03; H02K 2213/03

(57) ABSTRACT

A PCB stator for an axial flux electrical machine includes at least first and second conductive layers. Each electrical phase winding is formed from an alternating sequence of circumferentially distributed first and second spokes. Each of the first spokes has a radially inner end and a radially outer end and is inclined in a first circumferential direction, and each of the second spokes has a radially inner end and a radially outer end and is inclined in a second circumferential direction opposite the first circumferential direction. The first spokes are disposed in the first conductive layer in M/2 circumferentially distributed groups of N first spokes and the second spokes are disposed in the second conductive layer in M/2 circumferentially distributed groups of N second spokes. The radially outer ends of the first spokes are electrically connected to radially outer ends of the second spokes and radially inner ends of the first spokes are electrically connected to radially inner ends of the second spokes such that the alternating sequence of the first and second spokes spans 360*N physical degrees, N being an integer>=1.

### CROSS-REFERENCE TO RELATED APPLICATION

This application claims priority and the benefit of U.S. provisional patent application No. 63/592,389 filed on Oct. 23, 2023, the entire contents of which are incorporated by reference in this application, where permitted.

### FIELD OF THE DISCLOSURE

The disclosure generally relates to the field of axial flux electrical machines.

### BACKGROUND

One example of a coreless axial flux electrical machine is disclosed in WO 2023/082002 published May 19, 2023. This publication shows a water pump application which employs a printed circuit board (PCB) to carry the stator windings in a coreless architecture or topology. The use of such PCB stators enables the electrical machine to be quite compact compared to conventional radial flux topologies.

The coreless PCB stator results in an electrical machine that has losses dominated by copper losses. The copper losses are dependent on the resistance of a given winding design. Reducing the resistance of the winding printed on the PCB can offer improved efficiency.

The cost of the PCB stator is driven by the area of the PCB, the number of PCB layers and the thickness of the copper-foil layers. A reduced size/layer/thickness design could be beneficial to improve efficiency and/or reduce cost.

### SUMMARY

In one aspect, a stator for an axial flux electrical machine is provided which features a multi-layered substrate, including at least first and second conductive layers that are electrically insulated from one another. The first conductive layer includes a first sequence of circumferentially distributed first spokes, each first spoke having a radially inner end and a radially outer end and being inclined in a first circumferential direction. The second conductive layer includes a second sequence of circumferentially distributed second spokes, each second spoke having a radially inner end and a radially outer end and being inclined in a second circumferential direction, opposite the first circumferential direction. At least one electrical phase winding is provisioned. Each electrical phase winding is provisioned (at least partially) by an alternating sequence of the first and second spokes wherein radially outer ends of the first spokes are electrically connected to adjacent radially outer ends of the second spokes and radially inner ends of the first spokes are electrically connected to adjacent radially inner ends of the second spokes.

Each electrical phase winding can include an alternating sequence of the first and second spokes which spans 360*N physical degrees, N being an integer>=1.

N numbers of the first spokes can be grouped together and N numbers of the second spokes can be grouped together to form M stator poles, wherein each phase winding can be formed by an alternating sequence of first and second spokes selected from alternating ones of the first and second spoke groupings.

The aggregate number T1 of the first spokes can be T1=N*M/2*Ph and an aggregate number T2 of the second spokes can be T2=N*M/2*Ph, where Ph is the number of electrical phases and M is the number of stator poles per phase.

Each of the first and second spokes can be arcuate in form between the spoke's radially inner end and radially outer end. Alternatively, each of the first and second spokes can be linear in form between the spoke radially inner end and radially outer end.

The stator can be formed by a printed circuit board (PCB) having conductive copper-foil layers.

The stator can also include third and fourth conductive layers each of which is electrically insulated from each other and each of the first and second conductive layers. The third conductive layer can include a third sequence of circumferentially distributed third spokes, each third spoke having radially inner and outer ends and being inclined in the first circumferential direction, wherein each third spoke is arranged in an overlapping relationship with a corresponding one of the first spokes and electrically connected in parallel with the corresponding one of the first spokes. The fourth conductive layer can include a fourth sequence of circumferentially distributed fourth spokes, each fourth spoke having radially inner and outer ends and being inclined in the second circumferential direction, and wherein each fourth spoke is arranged in an overlapping relationship with a corresponding one of the second spokes and is electrically connected in parallel with the corresponding one of the second spokes.

According to another aspect, an axial flux electrical machine is provided which includes at least one stator and at least one rotor electromagnetically coupled to the at least one stator. Each such stator includes a multi-layered substrate, including at least first and second conductive layers that are electrically insulated from one another. The first conductive layer includes a first sequence of circumferentially distributed first spokes, with each first spoke having a radially inner end and a radially outer end and being inclined in a first circumferential direction. The second conductive layer includes a second sequence of circumferentially distributed second spokes, with each second spoke having a radially inner end and a radially outer end and being inclined in a second circumferential direction, opposite the first circumferential direction. The stator has at least one electrical phase winding. Each electrical phase winding is provisioned by an alternating sequence of the first and second spokes, where radially outer ends of the first spokes are electrically connected to radially outer ends of the second spokes and radially inner ends of the first spokes are electrically connected to radially inner ends of the second spokes. Rach rotor including a series of permanent magnets of alternating polarity.

According to another aspect a stator for an axial flux electrical machine is provided which includes a printed circuit board (PCB) having at least first and second conductive layers that are electrically insulated from one another. The PCB includes at least one electrical phase winding, with each electrical phase winding being formed at least in part from an alternating sequence of circumferentially distributed first and second spokes. The first spokes are disposed in the first conductive layer in M/2 circumferentially distributed groups of N first spokes and the second spokes are disposed in the second conductive layer in M/2 circumferentially distributed groups of N second spokes. Each of the first spokes has a radially inner end and a radially outer end and is inclined in a first circumferential direction, and each of the second spokes has a radially inner end and a radially outer end and is inclined in a second circumferential direction opposite the first circumferential direction. The radially outer ends of the first spokes are electrically connected to radially outer ends of the second spokes and radially inner ends of the first spokes are electrically connected to radially inner ends of the second spokes such that the alternating sequence of the first and second spokes spans 360*N physical degrees, N being an integer>=1.

A stator according to this aspect can have an aggregate number T1 of the first spokes, where T1=N*M/2*Ph and an aggregate number T2 of the second spokes, where T2=N*M/2*Ph, Ph being the number of electrical phases and M being the number of poles per phase. Each of the first and second spokes can be arcuate in form between the radially inner end and radially outer end of the spoke.

A stator according to this aspect can include third and fourth conductive layers, each of which is electrically insulated from the other and from each of the first and second conductive layers. The third conductive layer can include a third sequence third spokes, with each third spoke having radially inner and outer ends and being inclined in the first circumferential direction. Each third spoke can be arranged in an overlapping relationship with a corresponding one of the first spokes and electrically connected in parallel with the corresponding one of the first spokes. The fourth conductive layer can include a fourth sequence of fourth spokes, with each fourth spoke having radially inner and outer ends and being inclined in the second circumferential direction. Each fourth spoke can be arranged in an overlapping relationship with a corresponding one of the second spokes and electrically connected in parallel with the corresponding one of the second spokes. The first, second, third and fourth spokes can be connected at their radially outer ends by a circumferential series of straight vias and can be connected at their radially inner ends by another circumferential series of straight vias.

### BRIEF DESCRIPTION OF THE DRAWINGS

The foregoing and other aspects of the invention will now be described in greater detail, by way of example only, with reference to the attached drawings, in which:

FIG. 1 is a schematic diagram of a prior art basic coil winding pattern for an axial flux PCB stator;

FIG. 2 is a plan view of a prior art three-phase axial flux PCB stator formed utilizing the basic coil winding pattern shown in FIG. 1;

FIG. 3 is a schematic diagram of a coil winding pattern for an electrical phase of an axial flux stator;

FIG. 4 is a schematic diagram of the coil winding pattern shown in FIG. 3, including a partial electrical conduction path;

FIG. 5 is a plan view of a three-phase axial flux PCB stator formed utilizing the coil winding pattern shown in FIG. 3;

FIG. 6A is a not-to-scale cross-sectional view of a prior art three phase, axial flux PCB stator which utilizes the basic coil winding pattern shown in FIG. 1;

FIG. 6B is a not-to-scale cross-sectional view of a three phase, axial flux PCB stator which utilizes the coil winding pattern shown in FIG. 3;

FIG. 7 is a comparative plan view, comparing the relative size of the prior art three-phase axial flux PCB stator shown in FIG. 2 against the three-phase axial flux PCB stator shown in FIG. 5;

FIG. 8 is a schematic view of a permanent magnet rotor that can be electromagnetically coupled to the PCB stator shown in FIGS. 5; and

FIG. 9 is a schematic diagram of a permanent magnet rotor showing the positions of sector-shaped magnets.

### DETAILED DESCRIPTION OF EXAMPLE EMBODIMENTS

### Interpretation

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise explained, all technical and scientific terms used herein have the same meaning as commonly understood by one of ordinary skill in the art to which this disclosure belongs.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

The indefinite article “a” is not intended to be limited to mean “one” of an element. It is intended to mean “one or more” of an element, where applicable, (i.e. unless in the context it would be obvious that only one of the element would be suitable). The phrase “at least one of” is understood to be one or more. The phrase “at least one of . . . and . . . ” is understood to mean at least one of the elements listed or a combination thereof, if not explicitly listed. For example, “at least one of A, B, and C” is understood to mean A alone or B alone or C alone or a combination of A and B or a combination of A and C or a combination of B and C or a combination of A, B, and C.

It will also be noted that the use of the term “a” or “an” will be understood to denote “at least one” in all instances unless explicitly stated otherwise or unless it would be understood to be obvious that it must mean “one”. The phrase “at least one of” is understood to be one or more. The phrase “at least one of . . . and . . . ” is understood to mean at least one of the elements listed or a combination thereof, if not explicitly listed. For example, “at least one of A, B, and C” is understood to mean A alone or B alone or C alone or a combination of A and B or a combination of A and C or a combination of B and C or a combination of A, B, and C.

It will be understood that any component defined herein as being included may be explicitly excluded from the claimed invention by way of proviso or negative limitation, such as any specific components or method steps, whether implicitly or explicitly defined herein.

In addition, all ranges given herein include the end of the ranges and also any intermediate range points, whether explicitly stated or not.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The abbreviation, “e.g.” is derived from the Latin exempli gratia, and is used herein to indicate a non-limiting example. Thus, the abbreviation “e.g.” is synonymous with the term “for example.” The word “or” is intended to include “and” unless the context clearly indicates otherwise.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Any reference to upper, lower, top, bottom or the like are intended to refer to a relative orientation of a particular element in relation to other elements and not necessarily in absolute terms, or to orientation during manufacture, shipping or use. The upper surface of an element, for example, can still be considered an upper surface in relation to another surface even when the element is lying on its side or upside down.

### Prior Art Coil Winding Pattern

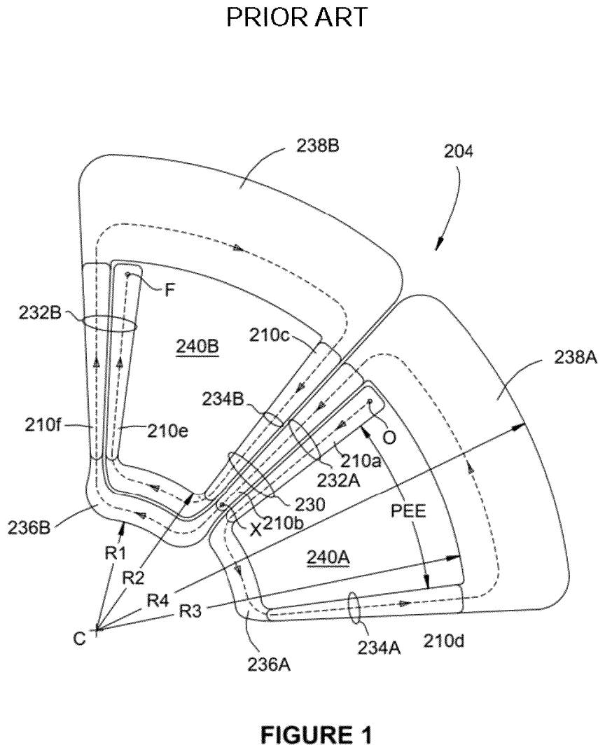

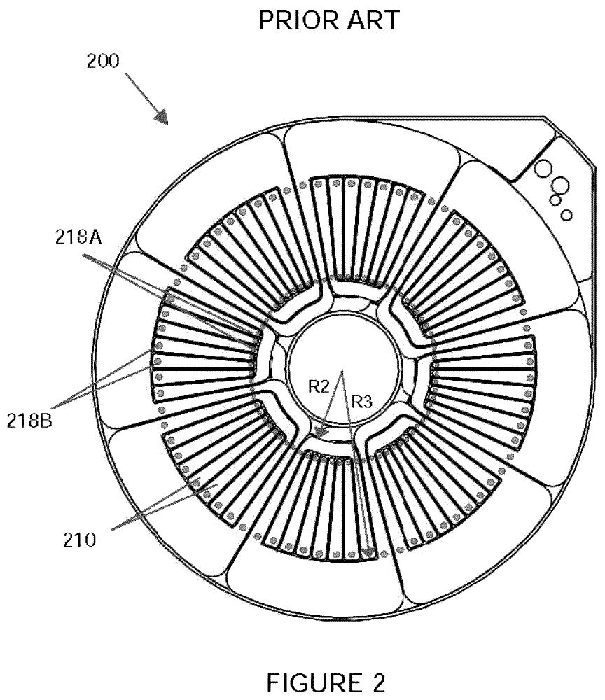

FIG. 1 shows a basic coil winding pattern 204 disclosed in WO 2023/082002 published May 19, 2023, which forms part of a phase winding for a printed circuit board (PCB) stator. The basic winding pattern in the plan view of FIG. 1 has a shape substantially corresponding to a sector of a circle, with radii R1, R2, R3 and R4 extending from a center point C of the circle. The winding pattern 204 comprises a plurality of circumferentially distributed (i.e., spread out along a direction tangential to the radii of the circle), radially orientated traces or spokes 210a-210f, that are laid out between radii R2 and R3. It will be seen in FIG. 1 that three immediately adjacent spokes 210a, 210b, 210c can be ganged together in a grouping 230 to enable the same direction of current flow and thus realize one stator pole. The winding pattern 204 can be formed by starting at an origin point O at a radial distance proximate to the length of radii R3 on one of the spokes 210a and interconnecting a set 232A of n=2 sequential spokes 210a and 210b with a set 234A of n−1=1 other sequential spoke(s) 210d disposed at a circumferential distance PEE (being the pole edge-to-edge distance) away from the set 232A utilizing inner circumferential trace(s) 236A and outer circumferential trace(s) 238A to intermediate point X at a radial distance from center point C proximate to the length of radii R2 on outer spoke 210b of spoke set 232A such that a coil 240A formed thereby is wound in a first winding direction. The coil pattern 204 continues from intermediate point X, encompassing a set 232B of n=2 sequential spokes 210e, 210f with a set 234B of n−1=1 additional other sequential spoke(s) 210c disposed at a circumferential distance PEE (being the pole edge-to-edge distance) away from the set 232B utilizing inner circumferential trace(s) 236B and outer circumferential trace(s) 238B to final point F at radial distance from center point C proximate to the length of distance R3 on an outermost spoke 210e of the spoke set 232B such that a coil 240B formed thereby is wound in a second winding direction, opposite the first winding direction. The winding pattern 204 can alternatively be described as commencing from point F and terminating at point O. It will be appreciated that winding pattern 204 forms the basis for a pair of alternating poles or ‘pole pair’. As shown in WO 2023/082002 the basic coil winding pattern 204 can be etched in multiple copper-foil layers of a PCB and various numbers of the spokes 210 can be ganged together to form a pole. FIG. 2 is a plan view of a prior art twelve-copper layer PCB stator 200 which utilizes the winding pattern 204. Each PCB copper layer includes seventy-two spokes 210. The spokes 210 on the various PCB layers are angularly aligned in an overlapping stacked relationship and electrically connected together in parallel through a distributed series of straight vias 218A, 218B disposed proximate to R2 and R3, respectively. The spokes 210 are utilized in three phase winding patterns wherein, in each phase winding pattern, the basic coil winding pattern 204 of FIG. 1 is repeated four times to extend over three hundred and sixty degrees (mechanical) to form eight-poles, each pole utilizing three sequential spokes 210. The three phase winding patterns are mechanically offset from each other by 30 degrees to provide 120 electrical degrees angular offset. The prior art PCB stator 200 shown in FIG. 2 thus provisions a twenty-four-pole stator comprising three phases, eight poles per phase, where each pole utilizes three distinct sequential spokes 210.

### Wave Winding Pattern With Circumferentially Inclined Spokes

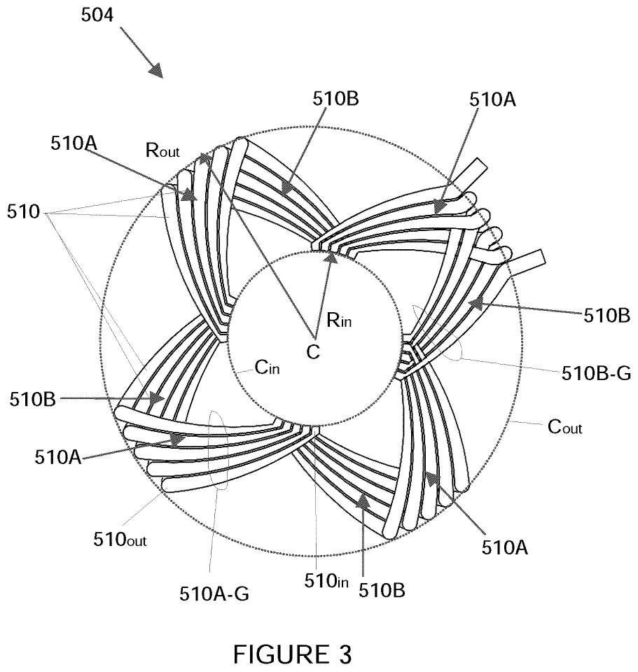

FIG. 3 shows a wave winding pattern 504 for an electrical phase of an axial flux stator. The wave winding pattern 504 shown in FIG. 3 can be embodied in the copper-foil layers of a printed circuit board (PCB), as described in greater detail below, or embodied through stampings and the like. In the plan view of FIG. 3 the wave winding pattern 504 is extends between inner and outer circumferences Cin and Cout extending along inner and outer radii Rin and Rout from a center point C of a notional circle. The wave winding pattern 504 comprises a plurality of circumferentially distributed (i.e., spread out along a direction tangential to the radii of the circle) traces or spokes 510, each having a radially inner end 510in and a radially outer end 510out and that extends between circumferences Cin and Cout. Each spoke 510 is, generally speaking, orientated in a radial direction between Cin and Cout whilst being circumferentially inclined or slanted away from the radial direction.

The electrical phase winding pattern 504 shown in FIG. 3 can be implemented in two or more PCB copper-foil layers, including a first copper-foil layer (not shown in its entirety in FIG. 3) etched to feature a first circumferentially distributed series of first spokes 510A, each of which is circumferential inclined or slanted in a first circumferential direction relative to Rout (when drawn to pass through the outer end of the spoke), and a second copper-foil layer (not shown in its entirety in FIG. 3) etched to feature a second circumferentially distributed series of second spokes 510B each of which is circumferential inclined or slanted in a second circumferential direction, opposite to the first circumferential direction, relative to Rout (when drawn to pass through the outer end of the spoke). The first spokes 510A are ganged together in M/2 groupings 510A-G, where M represents the number of poles in the electrical phase, with each group 510A-G composing a set of N sequential first spokes 510A. Likewise, the second spokes 510B are ganged together in M/2 groupings 510B-G, with each group 510B-G composing a set of N sequential second spokes 510B.

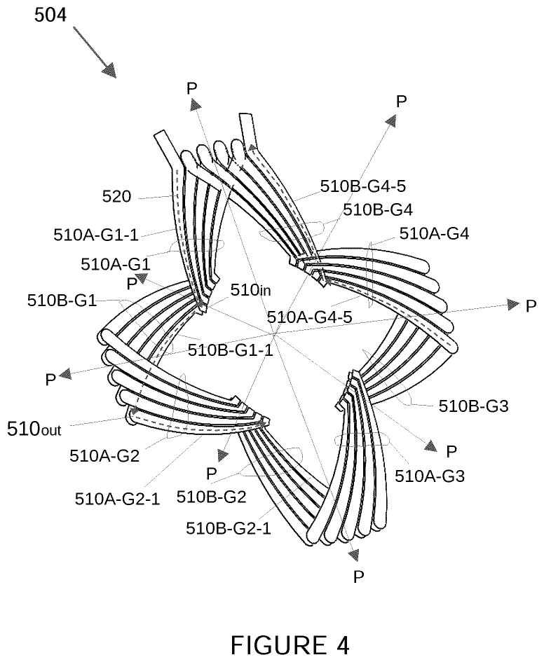

Referring additionally to FIG. 4 which shows a partial conduction path 520 in stippled lines in the illustrated embodiment where M is 8 and N is 5, it will be seen that the spokes 510 are connected as follows: A first spoke 510A-G1-1 of a first, first spoke grouping 510A-G1 is electrically connected to a first spoke 510B-G1-1 of a first, second spoke grouping 510B-G1 at the spoke inner ends 510 in. The first spoke 510B-G1-1 of the first, second spoke grouping 510B-G1 is electrically connected to a first spoke 510A-G2-1 of a second, first spoke grouping 510A-G2 at the spoke outer ends 510out. The first spoke 510A-G2-1 of the second, first spoke grouping 510A-G2 is electrically connected to a first spoke 510B-G2-1 of a second, second spoke grouping 510B-G2 at the spoke inner end 510out. The connection pattern continues with spokes of each first spoke grouping 510A being electrically connected to the spokes of adjacent second spoke groupings 510B at the spoke inner and outer ends 510in, 510out. The connection pattern in this embodiment terminates with a 5^{th} spoke 510A-G4-5 of a fourth, first spoke grouping 510A-G4 being electrically connected to a 5^{th} spoke 510B-G4-5 of a fourth, second spoke grouping 510B-G4 at the spoke inner ends 510 in. It will thus be seen that the phase wave winding pattern 504 in the illustrated embodiment loops mechanically for 360*5=1800 degrees, or more generally 360*N degrees. The wave winding pattern results in M poles, P, which are centered at the intersections of the first spoke groupings and second spoke groupings.

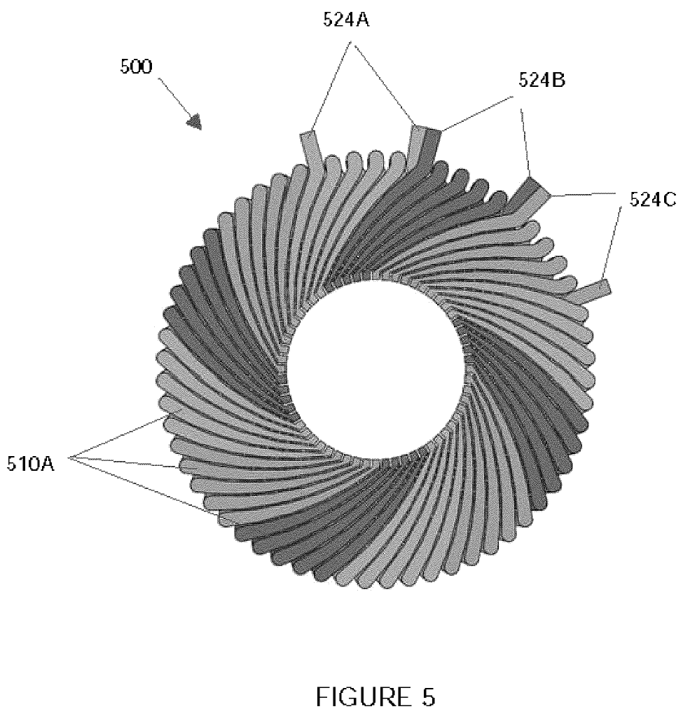

FIG. 5 shows a plan view of a PCB stator 500 which features three electrical phases, with each electrical phase being provisioned by the phase wave winding pattern 504. (In FIG. 5, only the first copper-foil layer is visible, which provisions the first circumferentially distributed series of first spokes 510A.) Trace extensions 524A, 524B and 524C provide the power terminals for the three electrical phases, respectively. If it is desired to substantially fill the area between Cin and Cout with spokes, i.e., if the ‘slot fill factor’ is 100%, the aggregate number of first spokes 510A will be equal to N*M/2*Ph and the aggregate number of second spokes 510B will be equal to N*M/2*P, where Ph is the number of electrical phases.

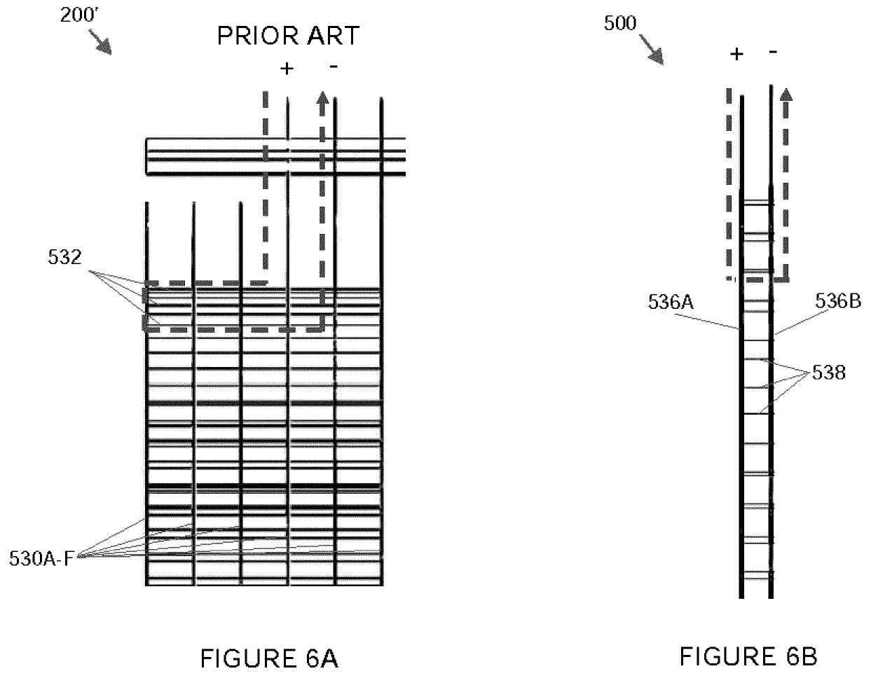

FIG. 6A shows cross-sectional views (not to scale) of a prior art six copper-foil layer PCB stator 200′ which utilizes the winding pattern 204 to implement three electrical phases. This winding pattern requires a minimum of two copper-foil layers per phase, hence a minimum of six copper-foil layers for three electrical phases. FIG. 6B shows a cross-sectional view of PCB stator 500 which utilizes the phase wave winding pattern 504 to implement three electrical phases. This winding pattern requires a minimum of two copper-foil layers for all three electrical phases. In FIG. 6A, current needs to travel across several of the six copper-foil layers 530A-530F through multilayer interconnection vias 532 whereas in FIG. 6B current needs to travel between two copper-foil layers 536A, 536B through two-layer interconnection vias 538. With the spoke widths being about the same, the I2R copper losses in PCB stator 200′ would be higher than the I2R copper losses in PCB stator 500.

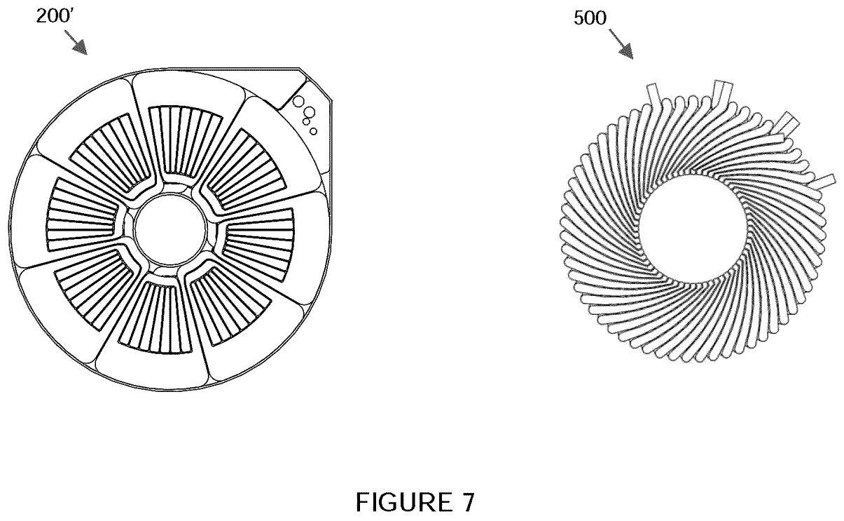

Referring additionally to FIG. 7 which shows prior art PCB stator 200′ relative to PCB stator 500 in plan view, another potential benefit of the PCB stator 500 relative to the prior art PCB stator 200′ is that PCB stator 500 does not require non-torque contributing portions of inner and outer circumferential conductors (such as traces 236A, 236B and 238A, 238B in FIG. 1) to interconnect the torque-contributing conductor spokes, which can result in reduced conductor path length and hence area. For example, FIG. 7 shows the relative area footrpints of the PCB stator 500 compared to the prior art PCB stator 200′ in order to achieve the same motor function at 150 W peak output with the same sector-shaped magnets for the rotor (not shown). It will be seen that the PCB stator 500 has an area that is approximately 40% less compared to the prior art PCB stator 200′, potentially decreasing cost.

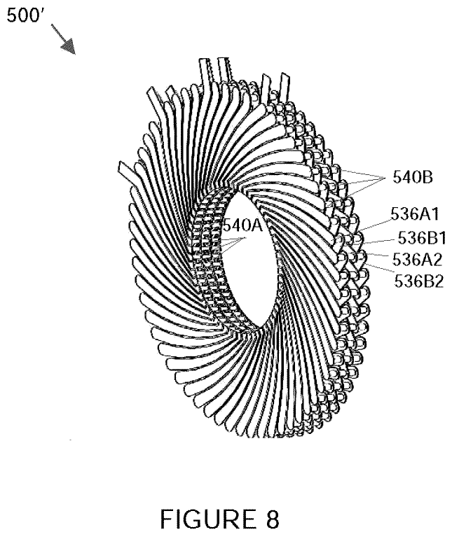

The PCB stator 500 as shown was constructed from a pair of PCB copper-foil layers, but such a PCB stator can alternatively be constructed from additional pairs of copper-foil layers. For example, FIG. 8 is a perspective view showing a three-phase, twenty-four pole PCB stator 500′ which utilizes two pairs of copper-foil layers 536A1, 536B1 and 536A2, 536B2. By splitting power across multiple conductive layers the overall ohmic resistance can be reduced. The PCB stator 500′ also conveniently requires only two circumferential series of vias 540A and 540B at Cin and Cout, respectively, running straight through the two pairs of copper-foil layers 536A1, 536B1 and 536A2, 536B2. It will be understood that alternative embodiments can employ more than two pairs of copper-foil layers.

Each spoke 510 has been shown in the illustrations as having an arcuate shape or segment as the spoke extends between Cin and Cout. In alternative embodiments each spoke can be formed from straight segments or combinations of straight and curvilinear segments. Each spoke 510 has also been shown in the illustrations to have a tapered shape, being wider in the circumferential direction near Cout and narrower in the circumferential direction near Cin. In alternative embodiments the taper may be omitted.

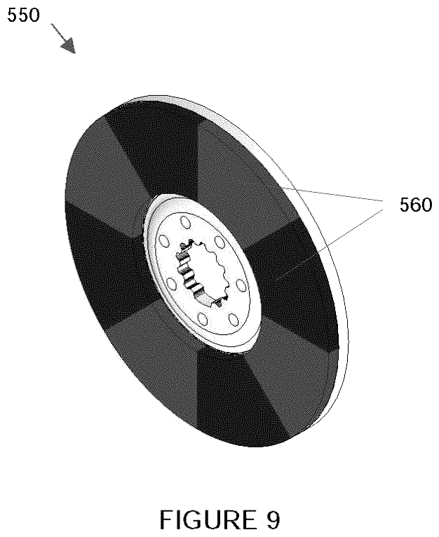

An electrical machine such as a motor or generator can be constructed by electromagnetically coupling the stator PCB 500 to at least one rotor carrying a multi-pole magnet, wherein the rotor is journaled for rotation in a housing (not shown) along an axial axis passing through the stator center C. For example, FIG. 9 is a schematic diagram of a permanent magnet rotor 550 showing the positions of sector-shaped magnets 560, where it will be seen that each sector-shaped magnet 550 has an included pole angle of 45 degrees mechanical resulting in an eight-pole rotor. Other magnet pole/stator pole variations are also possible. An axial flux electrical machine may be constructed utilizing a single PCB stator and single permanent magnet rotor, a single PCB stator and dual permanent magnet rotors straddling the stator, dual PCB stators straddling a single permanent magnet rotor, and electrical machines using multiple platens of the foregoing construction. The PCB stator 500 may also be replaced with stampings and the like fixed against a substrate or held in a medium such as epoxy. The constructional details of the foregoing electrical machines are omitted since they are not necessary to an understanding of the invention by persons skilled in the art.

Although specific constructions and advantages of the illustrated embodiment(s) have been enumerated above, persons skilled in the art will appreciate that there are yet more alternative implementations and modifications possible, and that the above examples are only illustrations of one or more implementations which may include some, none, or all of the enumerated advantages. The scope, therefore, is to be limited only by the appended claims.

1. A stator for an axial flux electrical machine, comprising:
a multi-layered substrate, including at least first and second conductive layers that are electrically insulated from one another;
the first conductive layer including a first sequence of circumferentially distributed first spokes, each first spoke having a radially inner end and a radially outer end and being inclined in a first circumferential direction;
the second conductive layer including a second sequence of circumferentially distributed second spokes, each second spoke having a radially inner end and a radially outer end and being inclined in a second circumferential direction, opposite the first circumferential direction;
at least one electrical phase winding, each electrical phase winding being provisioned at least partially by an alternating sequence of the first and second spokes wherein radially outer ends of the first spokes are electrically connected to adjacent radially outer ends of the second spokes and radially inner ends of the first spokes are electrically connected to adjacent radially inner ends of the second spokes.

2. A stator according to claim 1, wherein each electrical phase winding comprises an alternating sequence of the first and second spokes which spans 360*N physical degrees, N being an integer>=1.

3. A stator according to claim 2, wherein N numbers of the first spokes are grouped together and N numbers of the second spokes are grouped together to form M stator poles, and wherein each phase winding comprises an alternating sequence of said first and second spokes selected from alternating ones of said first and second spoke groupings.

4. A stator according to claim 3, wherein an aggregate number T1 of the first spokes is T1=N*M/2*Ph and an aggregate number T2 of the second spokes is T2=N*M/2*Ph, where Ph is the number of electrical phases and M is the number of stator poles per phase.

5. A stator according to claim 1, wherein each of the first and second spokes is arcuate in form between the spoke radially inner end and radially outer end.

6. A stator according to claim 5, wherein the stator is formed by a printed circuit board (PCB) having conductive copper-foil layers.

7. A stator according to claim 1, wherein each of the first and second spokes is linear in form between the spoke radially inner end and radially outer end.

8. A stator according to claim 1, including third and fourth conductive layers each of which is electrically insulated from each other and each of the first and second conductive layers, wherein:
the third conductive layer includes a third sequence of circumferentially distributed third spokes, each third spoke having radially inner and outer ends and being inclined in the first circumferential direction, wherein each third spoke is arranged in an overlapping relationship with a corresponding one of the first spokes and electrically connected in parallel with the corresponding one of the first spokes;
the fourth conductive layer includes a fourth sequence of circumferentially distributed fourth spokes, each fourth spoke having radially inner and outer ends and being inclined in the second circumferential direction, and wherein each fourth spoke is arranged in an overlapping relationship with a corresponding one of the second spokes and is electrically connected in parallel with the corresponding one of the second spokes.

9. An axial flux electrical machine, comprising:
at least one stator and at least one rotor electromagnetically coupled to the at least one stator;
each stator including a multi-layered substrate, including at least first and second conductive layers that are electrically insulated from one another, wherein the first conductive layer including a first sequence of circumferentially distributed first spokes, each first spoke having a radially inner end and a radially outer end and being inclined in a first circumferential direction; the second conductive layer including a second sequence of circumferentially distributed second spokes, each second spoke having a radially inner end and a radially outer end and being inclined in a second circumferential direction, opposite the first circumferential direction; and at least one electrical phase winding, wherein each electrical phase winding is provisioned by an alternating sequence of the first and second spokes wherein radially outer ends of the first spokes are electrically connected to radially outer ends of the second spokes and radially inner ends of the first spokes are electrically connected to radially inner ends of the second spokes; and
each rotor including a series of permanent magnets of alternating polarity.

10. A stator for an axial flux electrical machine, comprising:
a printed circuit board (PCB), including at least first and second conductive layers that are electrically insulated from one another;
at least one electrical phase winding, each electrical phase winding being formed at least in part from an alternating sequence of circumferentially distributed first and second spokes, wherein the first spokes are disposed in the first conductive layer in M/2 circumferentially distributed groups of N first spokes, wherein each of the first spokes has a radially inner end and a radially outer end and is inclined in a first circumferential direction, and wherein the second spokes are disposed in the second conductive layer in M/2 circumferentially distributed groups of N second spokes, wherein each of the second spokes has a radially inner end and a radially outer end and is inclined in a second circumferential direction opposite the first circumferential direction, wherein the radially outer ends of the first spokes are electrically connected to radially outer ends of the second spokes and radially inner ends of the first spokes are electrically connected to radially inner ends of the second spokes such that the alternating sequence of the first and second spokes spans 360*N physical degrees, N being an integer>=1.

11. A stator according to claim 10, wherein an aggregate number T1 of the first spokes is T1=N*M/2*Ph and an aggregate number T2 of the second spokes is T2=N*M/2*Ph, where Ph is the number of electrical phases and M is the number of poles per phase.

12. A stator according to claim 11, wherein each of the first and second spokes is arcuate in form between the radially inner end and radially outer end of the spoke.

13. A stator according to claim 12, including third and fourth conductive layers, each of which is electrically insulated from the other and from each of the first and second conductive layers, wherein:
the third conductive layer includes a third sequence third spokes, each third spoke having radially inner and outer ends and being inclined in the first circumferential direction, wherein each third spoke is arranged in an overlapping relationship with a corresponding one of the first spokes and electrically connected in parallel with the corresponding one of the first spokes;
the fourth conductive layer includes a fourth sequence of fourth spokes, each fourth spoke having radially inner and outer ends and being inclined in the second circumferential direction, and wherein each fourth spoke is arranged in an overlapping relationship with a corresponding one of the second spokes and is electrically connected in parallel with the corresponding one of the second spokes.

14. A stator according to claim 13, wherein the first, second, third and fourth spokes are connected at their radially outer ends by a circumferential series of straight vias and are connected at their radially inner ends by another circumferential series of straight vias.
